(19) United States
(12) Patent Application Publication
(10) Pub. No.: US 2013/0174789 A1
(43) Pub. Date: Jul. 11, 2013

(54) SQUIRREL DETERRENT FOR BIRD FEEDERS

(71) Applicant: Ken Koski, East Jordan, MI (US)

(72) Inventor: Ken Koski, East Jordan, MI (US)

(21) Appl. No.: 13/728,269

(22) Filed: Dec. 27, 2012

Related U.S. Application Data
(60) Provisional application No. 61/583,304, filed on Jan. 5, 2012.

(51) Int. Cl. A01K 39/01

(52) U.S. Cl. CPC A01K 39/0113
USPC 119/57.9

(57) ABSTRACT

Apparatus for deterring squirrels and other unwanted intruders from tampering with a bird feeder of the type mounted onto a vertical pole includes a hollow, electrically insulating form having an upper portion and a lower portion defining a length, the form being physically configured to fit around at least a portion of the vertical pole. First and second electrically conductive, spaced-apart wires are coupled lengthwise along the form such that they do not touch one another. A high-voltage power source is provided having first and second terminals, each terminal being electrically connected to a respective one of the wires, such that a squirrel or other intruding animal will receive a non-lethal shock if and when the animal makes contact with both of the wires at the same time.

### REFERENCE TO RELATED APPLICATIONS

This application claims priority to U.S. Provisional Patent Application Ser. No. 61/583,304, filed Jan. 5, 2012, the entire content of which is incorporated herein by reference.

### FIELD OF THE INVENTION

This invention relates generally to bird feeders and, in particular, to a high-voltage, non-lethal apparatus that keeps squirrels, chipmunks, and the like, from tampering with such feeders.

### BACKGROUND OF THE INVENTION

Those who feed birds with outdoor feeders are often frustrated when squirrels attack the feeder and steal the feed. As such, there have been many proposed designs to curtail such behavior. As one reference of many, U.S. Pat. No. 5,392,732 describes a squirrel-proof bird feeder including an electrical deterrent. The squirrel proof bird feeder comprises a bird feeding station, a conductive support pole attached to the bird feeder at one end and embedded within the ground at an opposing end, and a conducting plate affixed to, but electrically isolated from, the conductive support pole, and a regulating power supply providing electrical shock stimuli to animals contacting the conductive plate member and any earth ground, and more particularly the conductive support pole. In an alternate embodiment a plurality of isolated conductive plates are employed to provide a range of heights for the purpose of shocking a corresponding range of animal sizes. Yet another alternate embodiment employs a sensor which detects the imminent approach of an animal and activates the electrical power supply deterrent only when animals are present.

A problem with one embodiment of the design described above is that the pole itself is electrified. As such the apparatus is limited to the specialized system described and cannot be ‘retrofitted’ to existing feeding stations. Also, with the pole itself electrified the chance of human contact is increased, thereby raising the likelihood of a shock to people, including children.

Further, U.S. Pat. No. 5,392,732 has an alternate embodiment, wherein multiple horizontal platforms would be employed. This embodiment can even use a nonconductive vertical pole. However, the top surfaces of the multiple horizontal platforms would be the conductive plates, and these plates would have to be simultaneously contacted by the animal climbing the structure to be repelled. Essentially, standing on one platform and touching the next one up the pole, if the pole is nonconductive. To ensure performance of such a device, the spacing distances between the platforms now becomes critical. A large animal could reach over and/or around the plate necessary to be touched. An animal too small would stand on one platform and leap to the next, never contacting both simultaneously.

In addition, the devices described in the '732 patent utilize a horizontal platform as a conductive element. This is impractical, in that any horizontal platform is custom made to catch any and all debris falling from above. Much of this debris would have insulating qualities, such as droppings from the birds that are feeding, bird seed itself, leaves, dirt, even snow and ice. Thus, the squirrel (or other pest) will contact only the insulating debris lying on the platform, instead of the conductive horizontal plate itself, would not be shocked.

Another drawback is the dimensions of the horizontal platform as it protrudes from the pole. This could be critical. If the platform is small enough to reduce that catching of falling debris, the squirrel may be able to jump passed it, rather than climb onto it; that is, it might be perceived as too small an obstruction. On the other hand, if too large, the squirrel would jump to hang on the platform's outer edge. It could then climb on the platform, and without touching the conductive pole, leap upward to grasp the conductive pole higher up. But then contact between the horizontal platform in and conductive pole would not be simultaneous and not shock the animal.

In U.S. Pat. Nos. 5,285,747, 5,937,788, and 6,158,385, the inventors used feed containers that are in some fashion electrified. There are two major problems with these designs. First, the attending persons caring for the feed container expose themselves to shock. After all, the bird feeder itself is the shocking device. Secondly, the feed containers themselves must be ones that specifically include the adaptations for the electrical deterrence. This would seriously narrow the available products currently on the market, and may add significant costs.

### SUMMARY OF THE INVENTION

This invention resides in apparatus for deterring squirrels and other unwanted intruders from tampering with a bird feeder of the type mounted onto a vertical pole. The preferred embodiments include a hollow, electrically insulating form having an upper portion and a lower portion defining a length, the form being physically configured to fit around at least a portion of the vertical pole. First and second electrically conductive, spaced-apart wires are coupled lengthwise along the form such that they do not touch one another. A high-voltage power source is provided having first and second terminals, each terminal being electrically connected to a respective one of the wires, such that a squirrel or other intruding animal will receive a non-lethal shock if and when the animal makes contact with both of the wires at the same time.

Conveniently, each wire may begin at the bottom of the form, extend to the top of the form, then loop back to the bottom of the form such that, in cross section, the wires are arranged first-second-first-second circumferentially around the form, at 90 degrees, for example. The wires are preferably spaced-apart from the form with top and bottom stand-offs that extend outwardly from the form. The top and bottom stand-offs may be electrically insulating. The form may be hinged such that it clamps around the vertical pole.

In preferred installments, the upper portion of the form is positioned at least four feet above the ground, mort preferably five feet or more, such that the wires run lengthwise at least four feet along the form. The lower portion of the form may be positioned at least one foot feet above the ground enabling shorter forms to be used overall.

### BRIEF DESCRIPTION OF THE DRAWINGS

FIG. 1 depicts an embodiment of the invention where an insulated tube or pipe fits over the vertical shaft portion of a metal cane type feeder; and

FIG. 2 is a drawing that shows an embodiment of the invention wherein an ‘insulating pipe’ of proper diameter is hinged along its length so that it could open to encase the vertical structure then reclose around it.

### DETAILED DESCRIPTION OF THE INVENTION

This invention resides in a device that inhibits or stops squirrels and other such animals from taking advantage of bird feeders by providing a mild electric shock to the animal. The invention does not kill the squirrels or other uninvited guests; as such, the system uses a small electric shock to deter any other animals except the birds. The preferred embodiments do not limit a consumer's preference as to their feeder choice as the invention accommodates both conductive nonconductive poles. Furthermore, the poles can vary in diameter. As one example, the invention works well with the typical bird feeder stand retailed as a bent steel pole resembling a cane. It also fits a variety of different vertical stands.

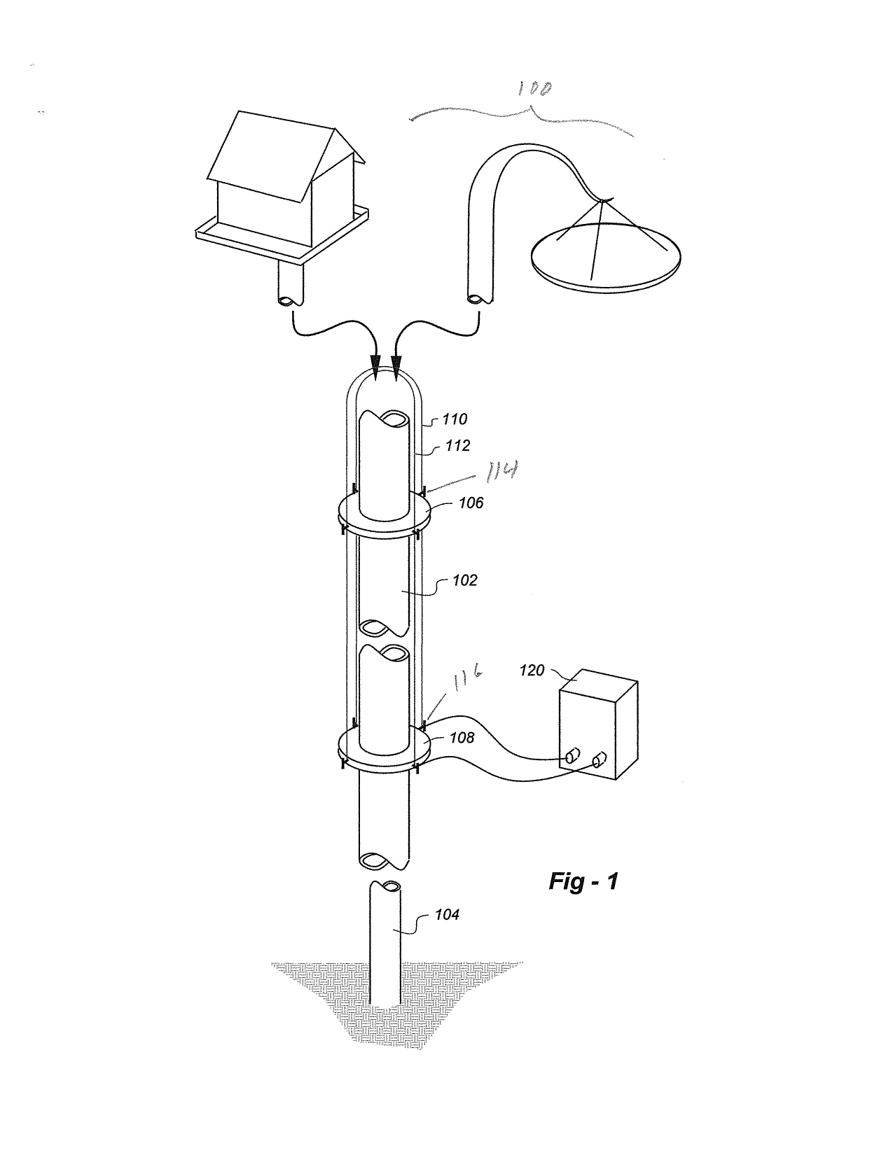

As shown in FIG. 1, one embodiment of the invention comprises an insulated tube or pipe 102 approximately four feet in length, though such length can be varied in accordance with the circumstances. For example, a length of PVC pipe may be well suited to this use. This tube or pipe 102 fits over the vertical shaft portion 104 of bird feeder(s) 100 of any design, with the diameter of the feeder's vertical rod 104 being slightly smaller than the inside diameter of the insulating pipe. It is not critical that the two diameters fit real close—it is simply that the arrangement offers better stability in the final product.

Several Internet articles indicate that squirrels may jump as much as five feet. This being the case, the deterrent preferably protects a vertical height of 1 to 5 feet, depending on whether the squirrel starts climbing from the ground or leaps upward. In other words, if the deterrent reached the ground, it may need to be about 4 to 5 feet long. If, however, the bottom of the deterrent is off the ground, the length of the deterrent may be reduced by the off-ground clearance. As such, the device may be adjusted vertically to accommodate the squirrel's (or other animal's) particular abilities.

At several points along the length of the insulating pipe 102 are insulated ‘standoffs’ 106, 108. The prototype uses three standoffs that encircle the pipe-but the number may vary. The standoffs may simply be threaded plastic pipe joints extending from the insulating pipe's outside surface, a distance of approximately ½ inch. The exact distance they protrude from the main pipe may be varied based on need. Four wire tie points 114, 116 extend radially outwardly from each standoff 106, 108. Assuming the standoffs are electrically insulating, the tie points may or may not be electrically conductive.

Running vertically along the length of the insulating pipe, and anchored to the standoffs with the tie points are wire conductors 110, 112, which may be thin galvanized wire, copper, aluminum, etc. As can be seen, there are four ‘runs’ of the conductors made of two wires. One wire 110 runs the length of the pipe, then repeats its run along the pipe again, but on the opposite side. The other wire 112 runs the length of the pipe, then repeats its run along the pipe again, but again on the opposite side. These conductors are placed 90 degrees apart if you were looking into the center of the pipe length wise, such that as one moves around the cross section of the deterrent, the wires are arranged 1-2-1-2.

At no point does one wire contact the other. If they come in contact, the installer may simply more them apart, or the top portions of one or both of the wires may be insulated. The number of conductors may be increased and angle between them varied based on need. If the standoffs are rotated a bit, an angle is made in the parallel runs of the wire relative to the centerline of the pipe. This would be permissible, so long as the wires do not contact each other. In some instances this may help deter animals.

The final step is the use of a fence-type shocker 120 commonly used to repel small animals (i.e., dogs, cats, etc.) from a garden. Such units typically generate a potential difference on the order of a few thousand volts or more. In its normal use this type of shocker will electrify two conductors, one of which is the earth or ground, the other being the fence. AC voltages may also be used, so long as any unwanted animal contacting both at the same time receives the shock. The shocker 120 is connected such that the two conductors running the length of the pipe are electrified on an alternating basis. As such, if a squirrel wishes to climb the pipe to the bird feeder, the squirrel would have to do so without touching the two conductors simultaneously. This would be extremely difficult based on the conductor placement, and length of pipe needed to be climbed. If and when the intruder does make contact with adjacent wires they receive a mild shock and are cast off of the feeder pole.

In contrast to the typical use of a ‘fence shocker,’ the design does not depend on a ‘ground’ contact. Therefore, a person standing on ‘ground’ who touches a single wire on the pipe will not get shocked. The ‘ground’ contact is needed with the use of the fence shocker. That is, for the fence shocker to repel an animal in its typical use (or shock a person) the animal must be in contact with the ground (like standing next to the fence), and make contact with the conductive fence itself. The animal's body then becomes the connection (conductor) for the current to flow from fence to ground.

In this design, the vertical feeder pole itself 104 is safe to touch, even if metal, since it has been anchored in the ground. Again, as mentioned above, any one single wire running the length of the insulated pipe may be handled without being shocked. Birds enjoy the provisions of the feeder, while squirrels and other intruders are positively discouraged. Also, the purchased bird feed container can be hung from the metal ‘cane’ without fear of shock, even if the container is metal. Only simultaneously contacting the two conductors running the length of the pipe will give a shock. Since the ‘fence charger’ is retailed to repel small animals (many of these chargers on the market) there is little concern as a hazard for humans.

The deterrent apparatus can easily be modified to mount around any vertical type structure of greater diameter, including round, square, or otherwise; using an insulated round, square other similarly fitting insulating tube. If the larger vertical structure were permanent, such that you could not slip the insulating pipe over it, then the approach is only slightly modified.

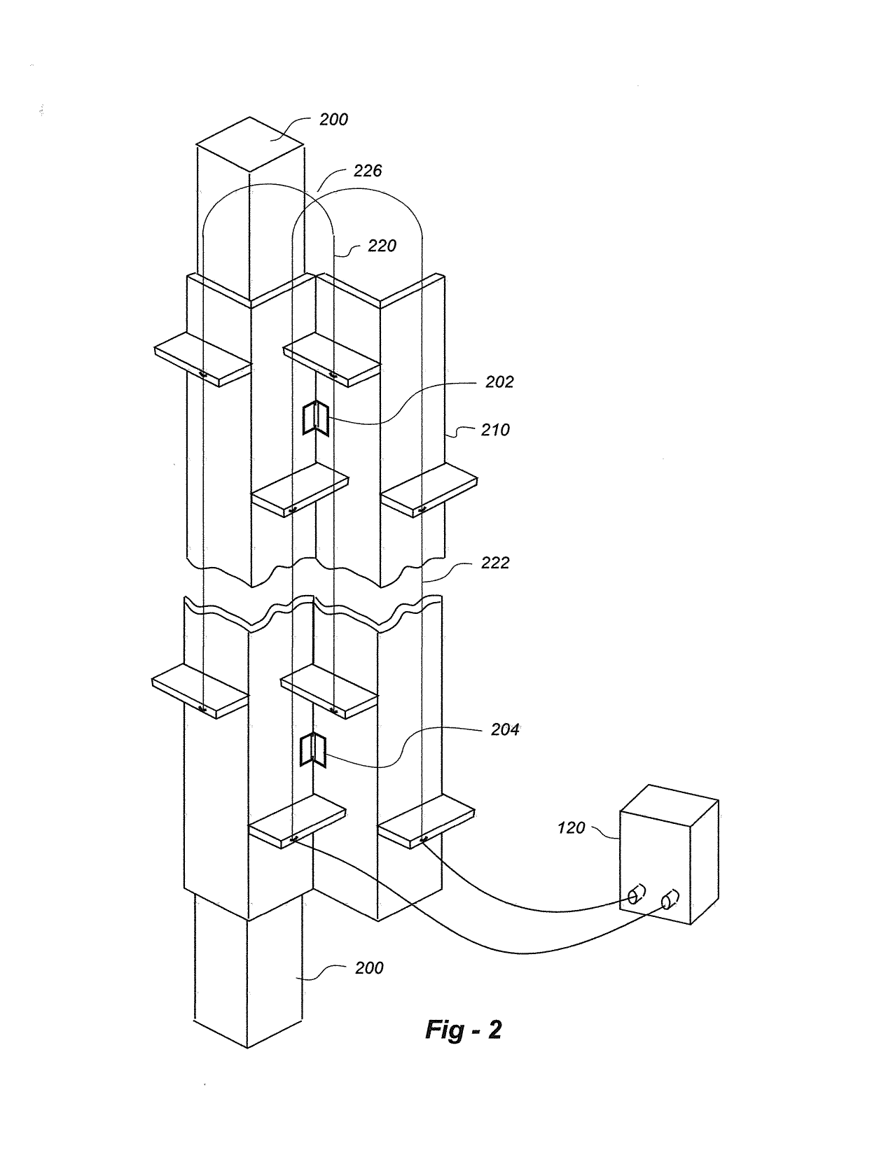

FIG. 2 shows an embodiment of the invention wherein the ‘insulating pipe’ 210 of proper diameter is hinged along its length so that it could open to encase the vertical structure then reclose around it. Of course, being that the diameter may be significantly larger than the prototype an additional modification would need to be considered. The number of parallel conductors may need to be increased. The increased number would allow a reduction in the distance between the parallel runs, increasing the probability of a squirrel contacting two at the same time.

The modified arrangement of FIG. 2 would thus ‘clamp’ itself around the diameter of post or pole 200. Once placed on the pole and closed, the flexible conductors 220, 222 would appropriately position themselves in parallel runs. The hinges 202, 204 are preferably non-conductive, with the total number being determined by the length of the length of the “clamshell” 210. Although a square clamshell arrangement is shown, certainly other cross-sectional geometries such as circular may be accommodated through appropriate engineering.

As with the other embodiments disclosed herein, conductive wires 220, 222 may include insulation is areas where touching may occur, as around region 226. The stand-offs, which may vary in number, may be constructed of any suitable non-conductive material such as PVC, glued or otherwise bonded to the outer surface of the clamshell pieces. The hinged clamshell structure is shown in the open position in FIG. 2. It may be closed and secured around post/pole 200 in various ways including spring-loaded hinges, adhesives, bonding tapes, etc. If the clamshell is made of wood or softer plastics, the wires 220, 222 may be stapled to the standoffs.

1. Apparatus for deterring squirrels and other unwanted intruders from tampering with a bird feeder of the type mounted onto a vertical pole, comprising:
a hollow, electrically insulating form having an upper portion and a lower portion defining a length, the form being physically configured to fit around at least a portion of the vertical pole;
first and second electrically conductive, spaced-apart wires coupled lengthwise along the form such that they do not touch one another; and
a high-voltage power source having first and second terminals, each terminal being electrically connected to a respective one of the wires, such that a squirrel or other intruding animal will receive a non-lethal shock if and when the animal makes contact with both of the wires at the same time.

2. The apparatus of claim 1, wherein each wire begins at the bottom of the form, extends to the top of the form, then loops back to the bottom of the form such that, in cross section, the wires are arranged first-second-first-second circumferentially around the form.

3. The apparatus of claim 1, wherein each wire begins at the bottom of the form, extends to the top of the form, then loops back to the bottom of the form such that, in cross section, the wires are arranged first-second-first-second at 90 degrees circumferentially around the form.

4. The apparatus of claim 1, wherein the wires are spaced apart from the form with top and bottom stand-offs that extend outwardly from the form.

5. The apparatus of claim 1, wherein the wires are spaced apart from the form with top and bottom electrically insulating stand-offs that extend outwardly from the form.

6. The apparatus of claim 1, wherein the form is hinged such that it clamps around the vertical pole.

7. The apparatus of claim 1, wherein the upper portion of the form is positioned at least four feet above the ground.

8. The apparatus of claim 1, wherein the wires run lengthwise at least four feet along the form.

9. The apparatus of claim 1, wherein the lower portion of the form is positioned at least one foot feet above the ground.
